(19) United States
(12) Patent Application Publication
(10) Pub. No.: US 2025/0058221 A1
(43) Pub. Date: Feb. 20, 2025

(54) VIRTUAL OBJECT DISPLAY METHOD AND APPARATUS

(71) Applicant: Tencent Technology (Shenzhen) Company Limited, Shenzhen (CN)

(72) Inventors: Wei QUAN, Shenzhen (CN); Wei FAN, Shenzhen (CN)

(21) Appl. No.: 18/937,006

(22) Filed: Nov. 4, 2024

Related U.S. Application Data
(63) Continuation of application No. PCT/CN2023/128504, filed on Oct. 31, 2023.

(30) Foreign Application Priority Data
Dec. 12, 2022 (CN) 202211596614.1

(51) Int. Cl. A63F 13/537; A63F 13/42; A63F 13/44

(52) U.S. Cl. CPC A63F 13/537; A63F 13/42; A63F 13/44

(57) ABSTRACT

A virtual object display method is provided. In the method, a virtual object in a virtual scene is displayed. The virtual object is configured to perform a plurality of attribute-affecting actions in the virtual scene. Each of the plurality of attribute-affecting actions includes a plurality of sub-actions. A first action trigger operation from a user is received. The first action trigger operation is associated with a first attribute-affecting action of the plurality of first attribute-affecting actions. One or more animations of the virtual object performing at least one first sub-action is displayed based on an attribute of the first action trigger operation.

### RELATED APPLICATIONS

The present application is a continuation of International Application No. PCT/CN2023/128504, filed on Oct. 31, 2023, which claims priority to Chinese Patent Application No. 202211596614.1, filed on Dec. 12, 2022. The entire disclosures of the prior applications are hereby incorporated by reference.

### FIELD OF THE TECHNOLOGY

This disclosure relates to the field of computer technologies, including to a virtual object display method and apparatus, a device, a medium, and a program product.

### BACKGROUND OF THE DISCLOSURE

In a virtual scene-based application program, a user may control, through a mobile end, a master virtual object to interact with another virtual object. During interaction, the user may input an instruction on the mobile end to operate the master virtual object to perform a plurality of attribute-affecting behaviors to perform various actions or behaviors with another virtual object.

In the related art, a virtual control of the mobile end is clicked/tapped, so that the master virtual object may be triggered to perform an attribute-affecting behavior corresponding to the virtual control, and interact with another virtual object.

However, in the foregoing manner of triggering a virtual object to perform a behavior through the virtual control, different virtual controls need to be set for different behaviors for triggering, and interface complexity is high, resulting in poor flexibility of object control, and reduction in human-computer interaction efficiency.

### SUMMARY

Embodiments of this disclosure provide a virtual object display method and apparatus, a device, a medium, and a program product, which can improve diversity of operating modes and efficiency of human-computer interaction. Examples of technical solutions are as follows:

According to an aspect, a virtual object display method is provided. In the method, a virtual object in a virtual scene is displayed. The virtual object is configured to perform a plurality of attribute-affecting actions in the virtual scene. Each of the plurality of attribute-affecting actions includes a plurality of sub-actions. A first action trigger operation from a user is received. The first action trigger operation is associated with a first attribute-affecting action of the plurality of first attribute-affecting actions. One or more animations of the virtual object performing at least one first sub-action is displayed based on an attribute of the first action trigger operation.

According to an aspect, a display apparatus, such as virtual object display apparatus is provided. The apparatus includes processing circuitry configured to display a virtual object in a virtual scene. The virtual object is configured to perform a plurality of attribute-affecting actions in the virtual scene. Each of the plurality of attribute-affecting actions includes a plurality of sub-actions. The processing circuitry is configured to receive a first action trigger operation from a user. The first action trigger operation is associated with a first attribute-affecting action of the plurality of first attribute-affecting actions. The processing circuitry is configured to display one or more animations of the virtual object performs at least one first sub-action based on an attribute of the first action trigger operation.

According to an aspect, a computer device is provided. The computer devices includes a processor and a memory, the memory having at least one instruction, at least one program, a code set or an instruction set stored therein, and the at least one instruction, the at least one program, the code set or the instruction set being loaded and executed by the processor to implement the virtual object display method according to any one of the foregoing embodiments of this disclosure.

According to an aspect, a non-transitory computer-readable storage medium is provided. The non-transitory computer-readable storage medium has at least one instruction, at least one program, a code set or an instruction set stored therein, the at least one instruction, the at least one program, the code set or the instruction set being loaded and executed by a processor to implement the virtual object display method according to any one of the foregoing embodiments of this disclosure.

According to an aspect, a computer program product or a computer program is provided, the computer program product or the computer program includes computer instructions, and the computer instructions are stored in a computer-readable storage medium. A processor of a computer device reads the computer instructions from the computer-readable storage medium and executes the computer instructions to cause the computer device to perform the virtual object display method according to any one of the foregoing embodiments.

Beneficial effects brought by technical solutions provided in the embodiments of this disclosure at least include:

An attribute-affecting behavior executable by a virtual object, such as a master virtual object, is decomposed into a plurality of segmented sub-behaviors. In this way, the same target control corresponds to a plurality of behaviors. In a case that a quantity of controls is limited, types of the behaviors executable by the master virtual object are increased. In addition, a behavior trigger operation meeting a time window requirement is performed on different controls, sequence numbers of the plurality of segmented sub-behaviors in the target control are switched, and segmented sub-behaviors obtained after a virtual object switches the sequence numbers are displayed, so that efficiency of human-computer interaction is improved and a content in a displayed picture is richer. A plurality of controls are triggered, the master virtual object performs the same attribute-affecting behavior, so that a many-to-one operation manner is implemented and diversity of user operation manners is improved.

### BRIEF DESCRIPTION OF THE DRAWINGS

FIG. 1 is a schematic diagram in which a virtual object is controlled to perform a single behavior through a target control according to an example of this disclosure.

FIG. 2 is a schematic diagram in which a single behavior that can be performed by a virtual object is preset by editing a target control according to an example of this disclosure.

FIG. 3 is a schematic diagram in which a virtual object is controlled to perform a single behavior through a sliding gesture according to an example of this disclosure.

FIG. 4 is a schematic diagram in which a virtual object is controlled to perform a plurality of stages of behaviors through a single target control according to an example of this disclosure.

FIG. 5 is a structural block diagram of an electronic device according to an example of this disclosure.

FIG. 6 is a structural block diagram of a computer system according to an example of this disclosure.

FIG. 7 is a flowchart of a virtual object display method according to an example of this disclosure.

FIG. 8 is a schematic diagram of a terminal screen according to an example of this disclosure.

FIG. 9 is a schematic diagram of displaying, based on a behavior trigger operation, a scene in which a virtual object performs a segmented sub-behavior according to an example of this disclosure.

FIG. 10 is a flowchart of a method for controlling a virtual object to display a segmented sub-behavior based on a quantity of times of behavior trigger operations according to an example of this disclosure.

FIG. 11 is a schematic diagram of cyclically displaying, based on a trigger cycle, a scene in which a virtual object performs a segmented sub-behavior according to an example of this disclosure.

FIG. 12 is a schematic diagram of determining a sequence number i of a first segmented sub-behavior based on a trigger cycle according to an example of this disclosure.

FIG. 13 is a flowchart of a method for counting behavior trigger operations based on a time window requirement according to an example of this disclosure.

FIG. 14 is a schematic diagram of performing, through an operation counter, an accumulative count on behavior trigger operations meeting a time window requirement according to an example of this disclosure.

FIG. 15 is a flowchart of a method for displaying a scene in which a virtual object performs an m^{th} second segmented sub-behavior according to an example of this disclosure.

FIG. 16 is a structural block diagram of a virtual object display apparatus according to an example of this disclosure.

FIG. 17 is a structural block diagram of a virtual object display apparatus according to another example of this disclosure.

FIG. 18 is a structural block diagram of a computer device according to an example of this disclosure.

### DETAILED DESCRIPTION

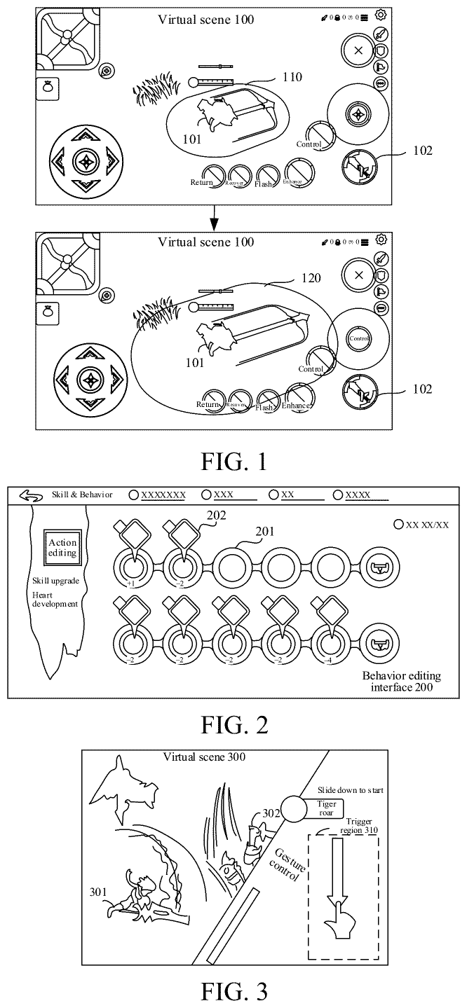

For example, as shown in FIG. 1, in a virtual scene 100, there is a master virtual object 101. The master virtual object 101 is controlled to cast a skill through a target control 102 on a terminal screen, and corresponding behavior actions are displayed in different ranges of the virtual scene 100. When the target control 102 is clicked/tapped, the master virtual object 101 may be controlled to perform an action in a first behavior range 110. After time for long pressing the target control 102 reaches a time threshold, the master virtual object 101 may be controlled to perform an action in a second behavior range 120.

For example, as shown in FIG. 2, in a behavior editing interface 200, there are a plurality of target controls 201. The target controls 201 are edited in advance, so that the target controls 201 can control the master virtual object to perform corresponding attribute-affecting behaviors 202. Different attribute-affecting behaviors 202 correspond to different target controls 201. The target control 201 is clicked/tapped on the terminal screen, so that the master virtual object can be controlled to perform the corresponding attribute-affecting behavior 202.

For example, as shown in FIG. 3, in a virtual scene 300, there is a master virtual object 301 and another virtual object 302. Different gesture instructions are inputted in a trigger region 310 on the terminal screen. For example, a sliding gesture is inputted in the trigger region 310, so that the master virtual object 301 can be controlled to perform various actions, or the master virtual object 301 can be controlled to interact with the another virtual object 302.

When the master virtual object is controlled to perform various actions, a target control usually corresponds to only one behavior action. When the target control is clicked/tapped to control the master virtual object to perform the corresponding action, diversity of operation manners cannot be met. Editing the target control to change an action corresponding to the target control brings an additional burden to an operation, and a quantity of target controls is limited, which cannot meet diversity of types of actions performed by the master virtual object. The master virtual object is triggered to perform an action in a manner of inputting an instruction through long pressing or sliding, causing a long time interval for the master virtual object to respond, poor instantaneity, and low human-computer interaction efficiency.

In embodiments of this disclosure, a target control corresponds to a plurality of stages of decomposed attribute-affecting behaviors. When a behavior trigger operation on a same target control is received, the master virtual object can be controlled to perform a plurality of attribute-affecting behaviors. Alternatively, a behavior trigger operation on another control is received, so that the master virtual object can be controlled to perform a specified behavior in the target control, and the master virtual object can perform switching at any time when performing the attribute-affecting behaviors. In this way, diversity of user operation manners can be improved, human-computer interaction efficiency is improved, and content in a displayed picture is richer.

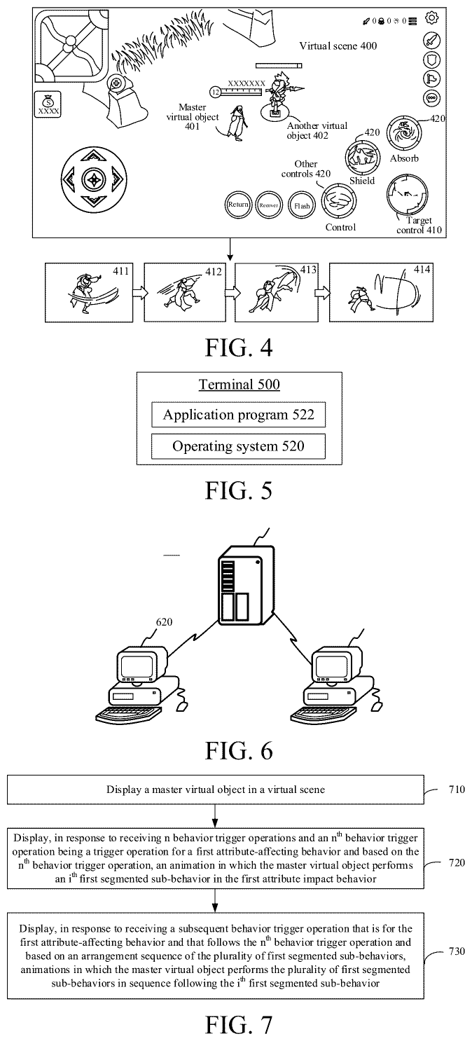

For example, as shown in FIG. 4, in a virtual scene 400, there is a master virtual object 401 and another virtual object 402. Instructions, that is, trigger operations, are inputted to a target control 410 and other controls 420, so that the master virtual object 401 can be controlled to perform various behavior actions and interact with another virtual object 402.

In some embodiments, there are four types of attribute-affecting behaviors (e.g., attribute-affecting actions) corresponding to the target control 410. The four types of attribute-affecting behaviors may be four stages of a same attribute-affecting behavior, or may be four independent attribute-affecting behaviors of a same type or different types. In this embodiment, an example in which the four types of attribute-affecting behaviors are the four stages of the same attribute-affecting behavior is used for description. The attribute-affecting behavior includes a first segmented sub-behavior 411 (e.g., sub-action), a second segmented sub-behavior 412, a third segmented sub-behavior 413, and a fourth segmented sub-behavior 414. An attribute-affecting behavior corresponding to each of the other controls 420 may include a single stage or a plurality of stages.

The target control 410 is clicked/tapped or the other controls 420 is clicked/tapped to trigger behavior operations, and the master virtual object 401 correspondingly performs different attribute-affecting behaviors.

An attribute of the master virtual object 401 includes, but is not limited to, the following types: a health value attribute, a power value attribute, an attack attribute, a defense attribute, a recovery attribute, a speed attribute, and the like.

When n consecutive behavior trigger operations meet a time window requirement, and an n^{th} behavior trigger operation is implemented on the target control 410, the master virtual object 401 may be controlled to perform, according to a quantity of times of behavior trigger operations, the attribute-affecting behavior corresponding to the target control 410.

Meeting the time window requirement means that each time interval between behavior trigger operations is less than a time threshold.

The n behavior trigger operations include at least one of the following cases:

When the n behavior trigger operations are all trigger operations on the target control 410, the first segmented sub-behavior 411, the second segmented sub-behavior 412, the third segmented sub-behavior 413, and the fourth segmented sub-behavior 414 are performed in sequence with the trigger operations on the target control 410.

When first n−1 behavior trigger operations in the n behavior trigger operations are trigger operations on the other controls 420, in the first n−1 behavior trigger operations, other behaviors corresponding to the other controls 420 are triggered, and in the n^{th} behavior trigger operation, an i^{th} segmented sub-behavior corresponding to the target control 410 is triggered based on a value of the quantity n, where the i^{th} segmented sub-behavior is any one of the first segmented sub-behavior 411, the second segmented sub-behavior 412, the third segmented sub-behavior 413, or the fourth segmented sub-behavior 414, and is determined based on the quantity n.

The terminal in this disclosure may be a desktop computer, a portable laptop computer, a mobile phone, a tablet computer, an ebook reader, a moving picture experts group audio layer III (MP3) player, a moving picture experts group audio layer IV (MP4) player, or the like. An application program supporting a virtual scene is installed and run on the terminal, such as an application program supporting a three-dimensional virtual scene. The application program may be any one of a virtual reality application program, a three-dimensional map program, a simulation game (SLG), and a multiplayer online battle arena (MOBA) game. In some embodiments, the application program may be a standalone application program, such as a standalone three-dimensional game application, or may be an online application program.

FIG. 5 is a structural block diagram of an electronic device according to an example of this disclosure. An electronic device 500 includes: an operating system 520 and an application program 522.

The operating system 520 is basic software provided for the application program 522 to perform secure access to computer hardware.

The application program 522 is an application program supporting a virtual scene. In some embodiments, the application program 522 is an application program supporting a three-dimensional virtual scene. The application program 522 may be any one of a VR application program, a three-dimensional map application, a TPS game, an FPS game, a MOBA game, and an SLG game. The application program 522 may be a standalone application program, such as a standalone three-dimensional game application, or may be an online application program.

FIG. 6 is a structural block diagram of a computer system according to an example of this disclosure. A computer system 600 includes: a first device 620, a server 640, and a second device 660.

An application program supporting a virtual scene is installed and run on the first device 620. The application program may be any one of a VR application program, a three-dimensional map application, a TPS game, an FPS game, a MOBA game, and an SLG game. The first device 620 is a device used by a first user. The first user uses the first device 620 to control the master virtual object located in the virtual scene to perform an activity. The activity includes, but is not limited to, at least one of adjusting body postures, walking, running, jumping, or attacking. For example, the master virtual object is a master virtual character such as a simulated character role or a cartoon character role.

The first device 620 is connected to the server 640 via a wireless network or a wired network.

The server 640 includes at least one of a server, a plurality of servers, a cloud computing platform, or a virtualization center. The server 640 is configured to provide a backend service for an application program supporting a three-dimensional virtual scene. In some embodiments, the server 640 is responsible for primary computing work, and the first device 620 and the second device 660 are responsible for secondary computing work. Alternatively, the server 640 is responsible for secondary computing work, and the first device 620 and the second device 660 are responsible for primary computing work; Alternatively, the server 640, the first device 620, and the second device 660 perform collaborative computing by using a distributed computing architecture among each other.

An application program supporting a virtual scene is installed and run on the second device 660. The application program may be any one of a VR application program, a three-dimensional map application, an FPS game, a MOBA game, and an SLG game. The second device 660 is a device used by a second user. The second user uses the second device 660 to control another virtual object located in the virtual scene to perform an activity. The activity includes, but is not limited to, at least one of adjusting body postures, walking, running, jumping, or attacking. at least one of adjusting body postures, walking, running, jumping, or attacking.

In some embodiments, the master virtual character and another virtual character are located in the same virtual scene. In some embodiments, the master virtual character and another virtual character may belong to the same team or the same organization, have a friend relationship, or have a temporary communication permission. In some embodiments, the master virtual character and another virtual character may alternatively belong to different teams, different organizations, or two groups hostile to each other.

In some embodiments, the application programs installed on the first device 620 and the second device 660 are the same, or the application programs installed on the two devices are the same type of application programs of different control system platforms. The first device 620 may generally refer to one of a plurality of devices, the second device 660 may generally refer to one of a plurality of devices. In this embodiment, a description is made by using only the first device 620 and the second device 660 as an example. The device types of the first device 620 and the second device 660 are the same or different. In the following embodiments, a description is made by using an example in which the device is a smartphone.

A person skilled in the art may learn that there may be more or fewer devices. For example, there may be only one device, or there may be dozens of or hundreds of or more devices. The quantity and the device type of the device are not limited in the embodiments of this application.

The server 640 may be implemented as a physical server or a cloud server in the cloud. The cloud technology is a hosting technology that unifies a series of resources such as hardware, software, and networks in a wide area network or a local area network to implement computing, storage, processing, and sharing of data. In some embodiments, when the server 640 is implemented as a cloud server, the program corresponding to the virtual scene may be a cloud game.

In some embodiments, the method according to the embodiments of this disclosure may be applied to a cloud gaming scenario, so that data logic calculation during a game is completed through the cloud server, and the terminal is responsible for displaying a game interface.

In some embodiments, the server 640 may alternatively be implemented as a node in a blockchain system.

The information (including, but not limited to, user equipment information, user personal information, and the like), data (including, but not limited to, data for analysis, stored data, displayed data, and the like), and signals involved in this disclosure all are authorized by the user or fully authorized by each party, and the collection, use, and processing of relevant data need to comply with relevant laws and regulations of relevant regions. For example, game data involved in this disclosure are all obtained with full authorization.

A virtual object display method provided in the embodiments of this disclosure is described with reference to the foregoing introduction of terms and descriptions of an implementation environment. FIG. 7 is a flowchart of a virtual object display method according to an example of this disclosure. An example in which the method is applied to a terminal is used for description. As shown in FIG. 7, the method includes the following operations.

Operation 710: Display a master virtual object in a virtual scene.

The master virtual object is equipped with a plurality of attribute-affecting behaviors in the virtual scene, the plurality of attribute-affecting behaviors includes a first attribute-affecting behavior, and the first attribute-affecting behavior includes a plurality of first segmented sub-behaviors arranged in sequence.

The attribute-affecting behavior is a behavior that can be performed by the master virtual object in the virtual scene, and an attribute of another virtual object is affected based on a behavior performed by the master virtual object.

A type of an attribute of a virtual object includes, but is not limited to, the following: 1. Health value: It is a health state attribute value of the virtual object. 2. Attack capability: It is a capability to cause harm to a health value of another virtual object when an attack behavior is performed. 3. Power value: It is an attribute that needs to be consumed in a process of casting a skill. To be specific, based on the fact that a virtual character has the power value, a skill can be cast based on the power value. 4. Defense value: It is an attribute that can weaken an attack power on the health value of the virtual object when an attack of another virtual object is defended against. 5. Speed attribute: It is an attribute that represents a movement speed of the virtual character during movement.

The first attribute-affecting behavior includes the plurality of first segmented sub-behaviors. The first attribute-affecting behavior is segmented according to a corresponding action or duration to obtain the plurality of first segmented sub-behaviors. After the plurality of first segmented sub-behaviors are arranged in sequence, each first segmented sub-behavior is an attribute-affecting behavior, or each first segmented sub-behavior is a stage of the first attribute-affecting behavior. In some embodiments, the plurality of first segmented sub-behaviors included in the first attribute-affecting behavior belong to a same behavior type, or the plurality of first segmented sub-behaviors belong to different behavior types. For example, the first attribute-affecting behavior is an attack behavior, and includes four first segmented sub-behaviors. A 1^{st} first segmented sub-behavior and a 3^{rd} first segmented sub-behavior are represented as attack actions, and a 2^{nd} first segmented sub-behavior and a 4^{th} first segmented sub-behavior are represented as defense actions. Alternatively, the first attribute-affecting behavior is an attack behavior, and includes four first segmented sub-behaviors. The four first segmented sub-behaviors are respectively represented as attack actions with different action performance.

The current terminal may control the master virtual object to move, perform various behaviors, and perform operations such as shape transformation in the virtual scene.

In the virtual scene, in addition to the master virtual object, another virtual object is further included. Another virtual objects includes, but is not limited to, the following types: (1) an opponent virtual object of the master virtual object; (2) a teammate virtual object of the master virtual object; and (3) a non player character (NPC) unrelated to the master virtual object.

The master virtual object is equipped with the first attribute-affecting behavior and other attribute-affecting behaviors. The current terminal may control the master virtual object to perform these attribute-affecting behaviors in the virtual scene and display animations in which the master virtual object performs the attribute-affecting behaviors on a terminal screen.

In some embodiments, the other attribute-affecting behaviors may include a plurality of other segmented sub-behaviors arranged in sequence, or may include only one behavior.

Operation 720: Display, in response to receiving n behavior trigger operations and an n^{th} behavior trigger operation being a trigger operation for the first attribute-affecting behavior and based on the n^{th} behavior trigger operation, an animation in which the master virtual object performs an i^{th} first segmented sub-behavior in the first attribute-affecting behavior.

The i^{th} first segmented sub-behavior is related to a quantity of times n of receiving the behavior trigger operations, n and i are positive integers, a time window requirement is met between operation moments of the n behavior trigger operations, and the time window requirement is that a time interval between two adjacent behavior trigger operations is less than a preset time threshold.

The behavior trigger operation is configured for controlling the master virtual object to perform a corresponding attribute-affecting behavior. A plurality of controls, namely a target control and other controls, are displayed on the current terminal screen, and different controls are clicked/tapped to trigger the master virtual object to perform behaviors respectively corresponding to the different controls.

In some embodiments, controlling the master virtual object to perform various attribute-affecting behaviors may be further triggered by an external input device, for example, triggered by a shortcut key on the external input device.

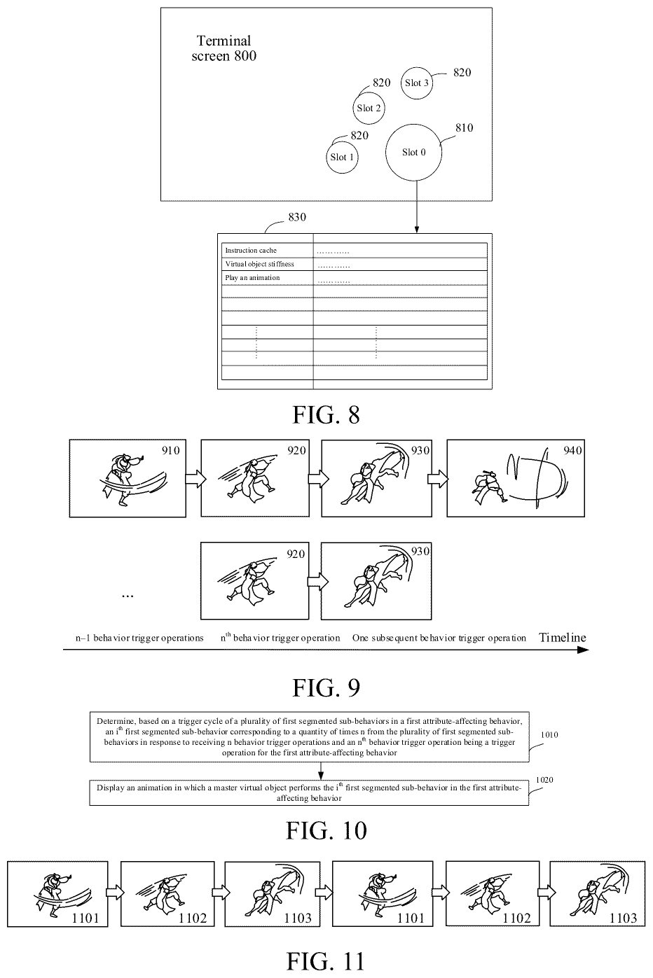

In this embodiment, an example in which a screen control is touched to trigger an attribute-affecting behavior is used for description. For example, as shown in FIG. 8, a plurality of controls are displayed on a terminal screen 800. An attribute-affecting behavior corresponding to a target control 810 is a first attribute-affecting behavior. In other words, a behavior trigger operation on the target control 810 may be configured for controlling the master virtual object to perform one or more first segmented sub-behaviors in the first attribute-affecting behavior. For example, if the target control 810 is triggered once, an animation in which the master virtual object performs a 1^{st} first segmented sub-behavior is displayed; and if the target control 810 is triggered for a plurality of times, when moments at which the target control 810 is triggered for the plurality of times meet the time window requirement, animations in which the master virtual object performs the plurality of first segmented sub-behaviors in the first attribute-affecting behavior are displayed in sequence, or when moments at which the target control 810 is triggered for the plurality of times do not meet the time window requirement, animations in which the master virtual object repeatedly performs the 1^{st} first segmented sub-behavior are displayed.

Attribute-affecting behaviors corresponding to other controls 820 are other attribute-affecting behaviors. In other words, behavior trigger operations on the other controls 820 may be configured for controlling the master virtual object to perform the other attribute-affecting behaviors; and Based on a quantity of times of triggering the other controls 820, animations in which the master virtual object performs the other attribute-affecting behaviors for the same quantity of times are displayed.

The target control 810 and the other controls 820 each have a respective corresponding configuration file. The configuration file is configured for implementing a process in which the master virtual object performs an attribute-affecting behavior, for example, the target control 810 corresponds to a target configuration file 830.

The target configuration file 830 includes, but is not limited to, the following content: (1) Instruction cache: It is configured for caching a received behavior trigger operation, and when the master virtual object meets a condition of performing an attribute-affecting behavior, an animation in which the master virtual object performs the attribute-affecting behavior is displayed based on a cached instruction. (2) Virtual object stiffness: It is configured for describing that in some cases, for example, when the master virtual object is attacked by an attack attribute-affecting behavior of another virtual object, the master virtual object is in an uncontrollable state. (3) Play an animation: Animation content in which the master virtual object performs an attribute-affecting behavior is displayed.

The displaying, in response to receiving n behavior trigger operations and an n^{th} behavior trigger operation being a trigger operation for the first attribute-affecting behavior, an animation in which the master virtual object performs an i^{th} first segmented sub-behavior in the first attribute-affecting behavior includes, but is not limited to, the following cases:

(1) When n is 1,
in response to receiving a single trigger operation for the first attribute-affecting behavior, an animation in which the master virtual object performs a 1^{st} first segmented sub-behavior in the first attribute-affecting behavior is displayed.

For example, the first attribute-affecting behavior includes four segmented sub-behaviors. The four segmented sub-behaviors are respectively: a 1^{st} first segmented sub-behavior, a 2^{nd} first segmented sub-behavior, a 3^{rd} first segmented sub-behavior, and a 4^{th} first segmented sub-behavior according to an arrangement sequence.

An animation in which the master virtual object performs the 1^{st} first segmented sub-behavior is displayed on the current terminal screen, or an animation in which the master virtual object interacts with another virtual object when performing a behavior is displayed.

(2) When n is an integer greater than 1,
in response to receiving n−1 behavior trigger operations for other attribute-affecting behaviors, animations in which the master virtual object performs the other attribute-affecting behaviors are displayed based on the n−1 trigger operations; and in response to receiving the n^{th} behavior trigger operation for the first attribute-affecting behavior, the animation in which the master virtual object performs the i^{th} first segmented sub-behavior in the first attribute-affecting behavior is displayed.

For example, each of the other attribute-affecting behaviors on which first n−1 behavior trigger operations are performed does not include a segmented sub-behavior.

The n−1 behavior trigger operations for the other attribute-affecting behaviors are received, a quantity of times of triggering the other attribute-affecting behaviors is counted, and when the n^{th} trigger operation for the first attribute-affecting behavior is received, a sequence number i of the first segmented sub-behavior performed by the master virtual object is determined based on the quantity of times of triggering the other attribute-affecting behaviors.

(3) The first n−1 behavior trigger operations include a trigger operation for one or more of the other attribute-affecting behaviors, and also include a trigger operation for the first attribute-affecting behavior. In this case, when the n^{th} behavior trigger operation is the trigger operation for the first attribute-affecting behavior, the animation in which the master virtual object performs the i^{th} first segmented sub-behavior in the first attribute-affecting behavior is displayed. A value of i is related to the quantity of times n.

The first attribute-affecting behavior may include any quantity of segmented sub-behaviors, there may be any quantity of times of receiving the behavior trigger operations, and the time window requirement may be random. This is not limited in this embodiment.

For example, a time window is a corresponding time interval when two adjacent behavior trigger operations are performed in the n behavior trigger operations. A time threshold is preset, and when a time interval from starting a former behavior trigger operation to receiving a latter behavior trigger operation is less than the time threshold, it is considered that the time window requirement is met between operation moments of the current two behavior trigger operations.

In some embodiments, the operation moments of the n behavior trigger operations all need to meet the time window requirement; or in a case that a quantity of behavior trigger operations whose time intervals are less than the time threshold in the n behavior trigger operations meets a preset quantity requirement, it is considered that the operation moments of the n behavior trigger operations all need to meet the time window requirement.

Operation 730: Display, based on an arrangement sequence of the plurality of first segmented sub-behaviors in response to receiving a subsequent behavior trigger operation that is for the first attribute-affecting behavior and that follows the n^{th} behavior trigger operation, animations in which the master virtual object performs the plurality of first segmented sub-behaviors in sequence following the i^{th} first segmented sub-behavior.

The time window requirement is met between operation moments of the subsequent behavior trigger operation and the n^{th} behavior trigger operation.

After the master virtual object is controlled to perform attribute-affecting behaviors corresponding to the foregoing n behavior trigger operations, a behavior trigger operation is received again, that is, the subsequent behavior trigger operation. The subsequent behavior trigger operation is for the first attribute-affecting behavior, and is configured for controlling the master virtual object to perform the segmented sub-behaviors in the first attribute impact behavior for display.

In some embodiments, one subsequent behavior trigger operation is received. In first n behavior trigger operations, an animation in which the master virtual object performs the 2^{nd} first segmented sub-behavior is displayed based on the n^{th} behavior trigger operation. In this case, the subsequent behavior trigger operation indicates the master virtual object to perform the 3^{rd} first segmented sub-behavior in sequence.

For example, as shown in FIG. 9, the first attribute-affecting behavior of the master virtual object includes a total of four segmented sub-behaviors: a 1^{st} first segmented sub-behavior 910, a 2^{nd} first segmented sub-behavior 920, a 3^{rd} first segmented sub-behavior 930, and a 4^{th} first segmented sub-behavior 940.

In response to receiving first n−1 behavior trigger operations for other attribute-affecting behaviors, animations in which the master virtual object performs the other attribute-affecting behaviors are displayed; in response to receiving an n^{th} behavior trigger operation for the first attribute-affecting behavior, an animation in which the master virtual object performs the 2^{nd} first segmented sub-behavior 920 in the first attribute-affecting behavior is displayed; and in response to receiving one subsequent behavior trigger operation that is for the first attribute-affecting behavior and that follows the n^{th} behavior trigger operation, an animation in which the master virtual object performs the 3^{rd} first segmented sub-behavior 930 in sequence following the 2^{nd} first segmented sub-behavior 920 is displayed based on an arrangement sequence of the plurality of first segmented sub-behaviors.

In some embodiments, the time window requirement is not met between the operation moments of the subsequent behavior trigger operation and the n^{th} behavior trigger operation.

In some embodiments, the animation in which the master virtual object performs the 2^{nd} first segmented sub-behavior is displayed based on the nth behavior trigger operation for the first attribute-affecting behavior. In this case, after a subsequent behavior trigger operation that does not meet the time window requirement is received, the master virtual object is indicated to perform the 1^{st} first segmented sub-behavior.

In other words, when the subsequent behavior trigger operation meets the time window requirement, subsequent segmented sub-behaviors are performed in sequence starting from the 2^{nd} first segmented sub-behavior; or when the subsequent behavior trigger operation does not meet the time window requirement, execution starts in sequence from the 1^{st} first segmented sub-behavior by default.

There may be any quantity of times of receiving subsequent behavior trigger operations, and the subsequent behavior trigger operation may be configured for controlling, based on the time window requirement and a segmented sub-behavior performed based on a former behavior trigger operation, the master virtual object to perform a latter segment sub-behavior with any sequence number for display.

In conclusion, the animations in which the master virtual object performs the other attribute-affecting behaviors are displayed by receiving the n−1 behavior trigger operations for the other attribute-affecting behaviors. When the n^{th} behavior trigger operation for the first attribute-affecting behavior is received, the animation in which the master virtual object performs the i^{th} first segmented sub-behavior in the first attribute-affecting behavior is displayed according to a correspondence between the quantity of times n−1 of the behavior trigger operations for the other attribute-affecting behaviors and the sequence number i of all the first segmented sub-behaviors in the first attribute-affecting behavior, so that diversity of operation manners can be improved, the master virtual object is controlled to perform more behaviors, human-computer interaction efficiency is improved, and content in a displayed picture is enriched.

According to the method provided in this embodiment, possible cases of the n received behavior trigger operations are discussed. The animation in which the master virtual object performs the 1^{st} first segmented sub-behavior in the first attribute-affecting behavior is displayed by receiving the single behavior trigger operation for the first attribute impact behavior. By receiving the n−1 behavior trigger operations for the other attribute impact behaviors, the n^{th} behavior trigger operation for the first attribute-affecting behavior is affected based on the quantity of times of behavior triggering, and the animations in which the master virtual object performs the segmented sub-behaviors in the first attribute-affecting behavior are displayed, so that diversity of operation manners can be improved, the master virtual object is controlled to perform the first attribute-affecting behavior through a plurality of behavior trigger operations, human-computer interaction efficiency is improved, and content in a displayed picture is enriched.

In some embodiments, receiving the n−1 behavior trigger operations for the other attribute-affecting behaviors correspondingly affects a sequence number of a segmented sub-behavior performed by the master virtual object when the n^{th} behavior trigger operation for the first attribute-affecting behavior is received. As shown in FIG. 10, FIG. 10 is a flowchart of a method for controlling a virtual object to display a segmented sub-behavior based on a quantity of behavior trigger operations according to an example of this disclosure. The method includes the following operations.

Operation 1010: Determine, based on a trigger cycle of a plurality of first segmented sub-behaviors in a first attribute-affecting behavior, an i^{th} first segmented sub-behavior corresponding to a quantity of times n from the plurality of first segmented sub-behaviors in response to receiving n behavior trigger operations and an n^{th} behavior trigger operation being a trigger operation for the first attribute-affecting behavior.

The trigger cycle is determined based on a quantity of first segmented sub-behaviors included in the first attribute-affecting behavior.

In some embodiments, if the quantity of first segmented sub-behaviors is 3, the trigger cycle of each first segmented sub-behavior is 3.

When a quantity of trigger operations for the first attribute-affecting behavior exceeds the trigger cycle, and an operation moment of each trigger operation meets a time window requirement, the master virtual object is controlled to cyclically perform each first segmented sub-behavior in sequence.

For example, as shown in FIG. 11, the first attribute-affecting behavior of the master virtual object includes a total of three segmented sub-behaviors: a 1^{st} first segmented sub-behavior 1101, a 2^{nd} first segmented sub-behavior 1102, and a 3^{rd} first segmented sub-behavior 1103, and a trigger cycle is 3.

When the quantity of trigger operations for the first attribute-affecting behavior is 6, the quantity of trigger operations exceeds the trigger cycle. If execution starts from the 1^{st} first segmented sub-behavior 1101, a corresponding segmented sub-behavior is cyclically performed for six times according to a sequence of the segmented sub-behaviors.

The trigger cycle may be random, and there may be any quantity of trigger operations for the first attribute-affecting behavior. This is not limited in this embodiment.

The determining, based on a trigger cycle of a plurality of first segmented sub-behaviors in a first attribute-affecting behavior, an i^{th} first segmented sub-behavior corresponding to a quantity of times n includes, but is not limited to, the following manners:

1. Obtain, based on a segment quantity of first segmented sub-behaviors in the first attribute-affecting behavior, a remainder of a ratio of the quantity of times n to the segment quantity, to obtain a value of i of the first segmented sub-behavior corresponding to the quantity of times n.

For example, the segment quantity of first segmented sub-behaviors in the first attribute-affecting behavior is four, that is, the first attribute-affecting behavior includes four first segmented sub-behaviors. A quantity of times of receiving the behavior trigger operations is ten, and if behavior trigger operations for the other attribute-affecting behaviors are received for first nine times, and a behavior trigger operation for the first attribute-affecting behavior is received for a tenth time,
a remainder of a ratio of the quantity of times to the segment quantity is obtained, that is, 10/4=2, and the remainder is 2. The value of i of the first segmented sub-behavior corresponding to the quantity of trigger operations is 2.

In response to receiving the tenth behavior trigger operation for the first attribute-affecting behavior, an animation in which the master virtual object performs a 2^{nd} first segmented sub-behavior is displayed. In other words, in a current case, if the behavior trigger operations for the other attribute-affecting behaviors are received for the first nine times, and the behavior trigger operation for the first attribute-affecting behavior is received for the tenth time, when the remainder of the ratio is obtained, other first segmented sub-behaviors in the first attribute-affecting behavior can directly follow a segmented sub-behavior corresponding to a ninth behavior trigger operation, to improve diversity of action generation.

2. Determine the value of i based on a correspondence between the quantity of times n of the behavior trigger operations and the sequence number i of the first segmented sub-behavior.

2.1. n=1.

A 1^{st} first segmented sub-behavior corresponding to the quantity of times n is determined from the plurality of segmented sub-behaviors in response to a value of the quantity of times n of the behavior trigger operations being 1.

When the value of the quantity of times n of the behavior trigger operations is 1, it indicates that only one behavior trigger operation for the first attribute-affecting behavior is received, and the 1^{st} first segmented sub-behavior in the first attribute-affecting behavior of the master virtual object is displayed by default.

2.2. n is greater than 1.

2.2.1. The i^{th} first segmented sub-behavior is randomly determined from the plurality of first segmented sub-behaviors in response to the value of the quantity of times n of the behavior trigger operations being greater than 1.

When the value of n is greater than 1, it indicates that behavior trigger operations for the other attribute-affecting behaviors are received.

In some embodiments, when the sequence number i of the first segmented sub-behavior is randomly determined, a random number may be generated as the sequence number i based on a rand function.

A quantity of segmented sub-behaviors in the first attribute-affecting behavior is used as a sequence number range, and the random number in the sequence number range is generated as the sequence number I by using the rand function.

A manner of randomly determining the sequence number i of the first segmented sub-behavior may be random, including but not limited to the foregoing examples. This is not limited in this embodiment.

2.2.2. A preset i^{th} first segmented sub-behavior is determined from the plurality of first segmented sub-behaviors in response to the value of quantity of times n of the behavior trigger operations being greater than 1.

In some embodiments, a manner of determining the sequence number i based on the quantity of times of triggering includes, but is not limited to, the following:

(1) A specified sequence relationship table is preset, and the specified sequence relationship table includes a correspondence between the quantity of times of triggering and the sequence number i of the segmented sub-behavior, as shown in the following Table 1.

TABLE 1

| Quantity of times | Sequence number i of |
|---|---|
| n−1 of triggering | a segmented sub-behavior |
| 1 ≤ n − 1 ≤ 2 | 1 |
| 2 < n − 1 ≤ 4 | 2 |
| 4 < n − 1 ≤ 6 | 3 |
| n − 1 > 6 | 4 |

That is, when the quantity of times of the triggers on the other attribute-affecting behaviors belong to different ranges, the n^{th} trigger operation on the first attribute-affecting behavior controls the master virtual object to perform a corresponding segmented sub-behavior.

In some embodiments, when the quantity of times n−1 of triggering is 4, when the n^{th} trigger operation for the first attribute-affecting behavior is received, the master virtual object is controlled to perform the 2^{nd} first segmented sub-behavior, and corresponding animation content is displayed on the current terminal screen.

An interval in which a value corresponding to the quantity of times of triggering falls is preset. Each interval corresponds to a sequence number. When the quantity of times of triggering falls in one interval, a sequence number corresponding to the interval is selected as the sequence number i of the first segmented sub-behavior.

That is, according to different quantities of times n, the i^{th} first segmented sub-behavior is determined in different manners, so that selectable diversity of behaviors can be improved.

(2) A specified function is preset, and the specified function is configured for performing a weighting operation between the quantity of times of triggering and the segment quantity of segmented sub-behaviors in the first attribute-affecting behavior, to obtain the sequence number i.

A manner of controlling the virtual object to display the i^{th} first segmented sub-behavior based on the quantity of times of the behavior trigger operations includes, but is not limited to, the foregoing several manners. This is not limited in this embodiment.

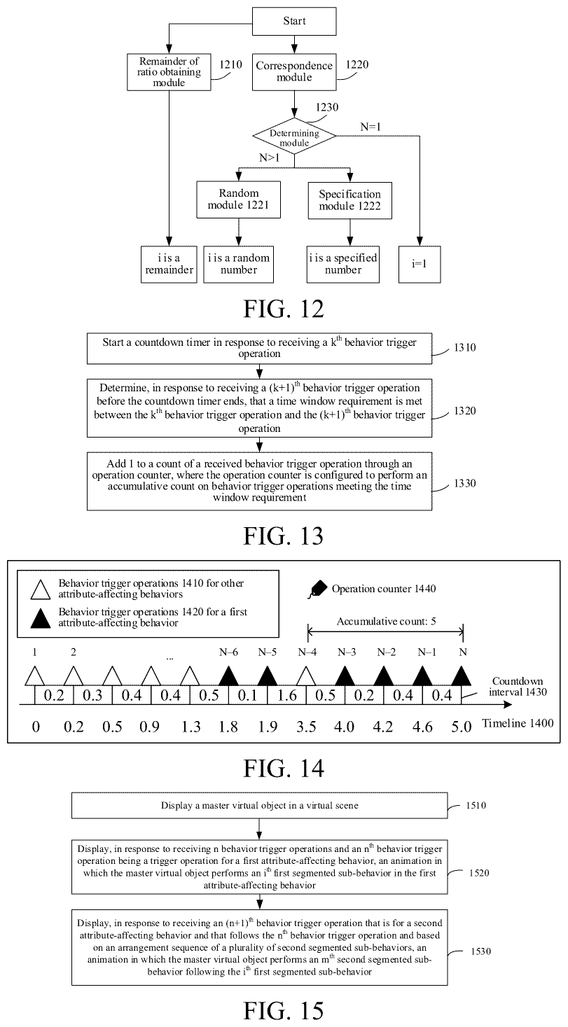

For example, as shown in FIG. 12, FIG. 12 is a schematic diagram of determining a sequence number i of a first segmented sub-behavior based on a trigger cycle.

A remainder of ratio obtaining module 1210 obtains a remainder of a ratio of the quantity of times n of triggering to the segment quantity, and the obtained remainder is the sequence number i.

A correspondence module 1220 obtains the sequence number i through the correspondence between the quantity of times n of triggering and the sequence number i. The correspondence module 1220 includes a random module 1221 and a specification module 1222. Based on a determining result of a determining module 1230 on the quantity of times n of triggering, the random module 1221 or the specification module 1222 is selected to further determine the sequence number i.

When the quantity of times n of triggering is 1, the sequence number i is 1 by default; and
when the quantity of times n of triggering is greater than 1, the random module 1221 generates a random number as the sequence number i, and the specification module 1222 determines a specified number as the sequence number i based on a preset relationship between the quantity of times n of triggering and the sequence number i.

In some embodiments, an odd or even number result corresponding to the quantity of times n is obtained; and the i^{th} first segmented sub-behavior corresponding to the odd or even number result is determined from the plurality of first segmented sub-behaviors based on a segment quantity of first segmented sub-behaviors in the first attribute-affecting behavior.

In this embodiment, the odd or even number result corresponding to the quantity of times of the behavior trigger operations is first determined. That is, the quantity of times n includes two cases: an odd number or an even number. Then, a first segmented sub-behavior corresponding to the quantity of times n is determined as the i^{th} first segmented sub-behavior according to the first segmented sub-behavior in the first attribute-affecting behavior. For example, when the quantity of times n is the even number, a first segmented sub-behavior arranged at an even-number position is determined from the first attribute-affecting behavior as the i^{th} first segmented sub-behavior (the 2^{nd} first segmented sub-behavior, the 4^{th} first segmented sub-behavior, or the like); or when the quantity of times n is the odd number, a first segmented sub-behavior arranged at an odd-number position is determined from the first attribute-affecting behavior as the i^{th} first segmented sub-behavior (the 1^{st} first segmented sub-behavior, the 3^{rd} first segmented sub-behavior, or the like). In other words, in response to the quantity of times n being an even number, a first segmented sub-behavior corresponding to the even number of times is determined from the plurality of first segmented sub-behaviors as the i^{th} first segmented sub-behavior; or in response to the quantity of times being an odd number, a first segmented sub-behavior corresponding to the odd number of times is determined from the plurality of first segmented sub-behaviors as the i^{th} first segmented sub-behavior.

In some embodiments, when there are a plurality of first segmented sub-behaviors at the even-number position/odd-number position, a first segmented sub-behavior is randomly selected as the i^{th} segmented sub-behavior.

In this embodiment, a manner of determining the i^{th} first segmented sub-behavior by using the odd or even number of the quantity of times n can expand diversity of manners of determining the first segmented sub-behavior.

Operation 1020: Display an animation in which the master virtual object performs the i^{th} first segmented sub-behavior in the first attribute-affecting behavior.

In some embodiments, the displaying an animation in which the master virtual object performs the i^{th} first segmented sub-behavior includes the following cases:

(1) When n is 1,
in response to receiving a single trigger operation for the first attribute-affecting behavior, an animation in which the master virtual object performs the 1^{st} first segmented sub-behavior in the first attribute-affecting behavior is displayed.

That when the single behavior trigger operation for the first attribute-affecting behavior is received, a behavior animation in which the master virtual object performs the 1^{st} first segmented sub-behavior is displayed on the current terminal screen includes: displaying an animation in which the master virtual object performs a segmented sub-behavior, or displaying an animation in which the master virtual object interacts with another virtual object when performing a segmented sub-behavior.

(2) When n is an integer greater than 1,
in response to receiving n−1 behavior trigger operations for other attribute-affecting behaviors, animations in which the master virtual object performs the other attribute-affecting behaviors are displayed based on the n−1 trigger operations; and in response to receiving the n^{th} behavior trigger operation for the first attribute-affecting behavior, the animation in which the master virtual object performs the i^{th} first segmented sub-behavior in the first attribute-affecting behavior is displayed.

In conclusion, the animations in which the master virtual object performs the other attribute-affecting behaviors are displayed by receiving the n−1 behavior trigger operations for the other attribute-affecting behaviors. When the n^{th} behavior trigger operation for the first attribute-affecting behavior is received, the animation in which the master virtual object performs the i^{th} first segmented sub-behavior in the first attribute-affecting behavior is displayed according to the quantity of times n−1 of the behavior trigger operations for the other attribute-affecting behaviors and the sequence number i of all the first segmented sub-behaviors in the first attribute-affecting behavior, so that diversity of operation manners can be improved, the master virtual object is controlled to perform more behaviors, human-computer interaction efficiency is improved, and content in a displayed picture is enriched

According to the method provided in this embodiment, the i^{th} first segmented sub-behavior corresponding to the quantity of times n is determined from the plurality of first segmented sub-behaviors based on the trigger cycle of the plurality of first segmented sub-behaviors in the first attribute-affecting behavior, so that a player can control the master virtual object to perform a target segmented sub-behavior and timely display a picture of performing the action, so as to improve the human-computer interaction efficiency.

According to the method provided in this embodiment, based on of the segment quantity of first segmented sub-behaviors in the first attribute-affecting behavior, the remainder of the ratio of the quantity of times n to the segment quantity is obtained to obtain the value of i of the first segmented sub-behavior corresponding to the quantity of times n. A rule of switching the segmented sub-behaviors in the first attribute-affecting behavior is provided, so that the player can control the master virtual object to perform more behaviors through a plurality of behavior trigger operations, so as to improve the human-computer interaction efficiency.

According to the method provided in this embodiment, the sequence number of the segmented sub-behavior is determined randomly or in a preset manner, and an animation in which the master virtual object performs a segmented sub-behavior corresponding to the sequence number is displayed, thereby improving richness of displayed content.

FIG. 13 is a flowchart of a method for counting behavior trigger operations based on a time window requirement according to an example of this disclosure. As shown in FIG. 13, the method includes the following operations.

Operation 1310: Start a countdown timer in response to receiving a k^{th} behavior trigger operation.

The countdown timer is a timer using the time window requirement as a timing length, and k is a positive integer less than n.

The k^{th} behavior trigger operation may be a behavior trigger operation for any attribute-affecting behavior. If the received k^{th} behavior trigger operation is for the first attribute-affecting behavior, the animation in which the master virtual object performs the i^{th} first segmented sub-behavior with a corresponding sequence in the first attribute-affecting behavior is displayed; if the received k^{th} behavior trigger operation is for other attribute-affecting behaviors, animations in which the master virtual object performs the other attribute-affecting behaviors are displayed; and displaying an animation in which the master virtual object performs the attribute-affecting behavior and starting the countdown timer for a k^{th} time are performed simultaneously.

In some embodiments, the time window requirement is that: an interval between operation moments of receiving two consecutive behavior trigger operations is within 0.5 s, that is, a timing length of the countdown counter is 0.5 with a unit of seconds.

When a behavior trigger operation is received, the countdown timer is immediately started to start countdown from 0.5, and when a next behavior trigger operation is received, the countdown timer is restarted.

In some embodiments, the timing length corresponding to the time window requirement may be random. This is not limited in this embodiment.

Operation 1320: Determine, in response to receiving a (k+1)^{th} behavior trigger operation before the countdown timer ends, that the time window requirement is met between the k^{th} behavior trigger operation and the (k+1)^{th} behavior trigger operation.

For example, the countdown timer is configured for determining a time interval between two adjacent behavior trigger operations.

In some embodiments, the countdown timer has a timing length of 0.5 with a unit of seconds.

When the k^{th} behavior trigger operation is received, the countdown timer is started to start countdown from 0.5. When the (k+1)^{th} behavior trigger operation is received before the countdown timer ends, the countdown timer corresponding to the k^{th} behavior trigger operation stops countdown, and a countdown timer corresponding to the (k+1)^{th} behavior trigger operation starts countdown from 0.5.

In other words, when a behavior trigger operation is received again within 0.5 s after the k^{th} behavior trigger operation is received, it is determined that the time window requirement is met between the k^{th} behavior trigger operation and the (k+1)^{th} behavior trigger operation.

The (k+1)^{th} behavior trigger operation may be a behavior trigger operation for any attribute-affecting behavior. When the (k+1)^{th} behavior trigger operation is received, displaying the animation in which the master virtual object performs the attribute-affecting behavior and starting the countdown timer for a (k+1)^{th} time are performed simultaneously.

In some embodiments, the time window requirement is not met between the k^{th} behavior trigger operation and the (k+1)^{th} behavior trigger operation.

(1) A time interval between receiving the k^{th} behavior trigger operation and receiving the (k+1)^{th} behavior trigger operation exceeds a timing length corresponding to a time window.

(2) No behavior trigger operation is received after the k^{th} behavior trigger operation is received.

When the countdown timer corresponding to the k^{th} behavior trigger operation ends, the countdown timer is gradually reduced from 0.5 to 0. In this case, the (k+1)^{th} behavior trigger operation is not received, the countdown timer is turned off, and timing is not started again.

In other words, the countdown timer calculates a time interval between two adjacent behavior trigger operations, so that whether the time interval between two adjacent behavior trigger operations meets the time window requirement can be improved, and accuracy of time interval calculation is improved.

Operation 1330: Add 1 to a count of a received behavior trigger operation through an operation counter, where the operation counter is configured to perform an accumulative count on behavior trigger operations meeting the time window requirement.

In some embodiments, the countdown timer has a timing length of 0.5 with a unit of seconds.

When a behavior trigger operation is received, an accumulative count is started from a current behavior trigger operation by using the operation counter, and behavior trigger operations that meet the time window requirement and that are consecutive are accumulated, to obtain an accumulated sum.

When the n^{th} behavior trigger operation is the behavior trigger operation for the first attribute-affecting behavior, the obtained accumulated sum determines that the n^{th} behavior trigger operation is configured for controlling the master virtual object to perform the i^{th} first segmented sub-behavior in the first attribute-affecting behavior.

For example, as shown in FIG. 14, FIG. 14 is a schematic diagram of performing, through an operation counter, an accumulative count on behavior trigger operations meeting a time window requirement.

An operation moment corresponding to each behavior trigger operation is recorded in a timeline 1400. A unit of the timeline 1400 is seconds, and the behavior trigger operation includes two types: a behavior trigger operation 1410 on the other attribute-affecting behavior and a behavior trigger operation 1420 on the first attribute-affecting behavior.

If a corresponding moment of receiving the first behavior trigger operation is 0, and a corresponding moment of receiving the second behavior trigger operation is 0.2, a countdown interval 1430 between receiving the first behavior trigger operation and the second behavior trigger operation is 0.2, and the time window requirement is met, which indicates that the second behavior trigger operation is received before a countdown timer corresponding to the first behavior trigger operation ends, and the operation counter 1440 performs the accumulative count on the first behavior trigger operation and the second behavior trigger operation.

By analogy, the operation counter 1440 starts counting from a first time that the behavior trigger operation is received, there are n−6 countdown intervals 1430 meeting the time window requirement, corresponding behavior trigger operations are: the first behavior trigger operation to an (n−5)^{th} behavior trigger operation, and an initial accumulated sum of the operation counter 1440 is n−5.

If a countdown interval 1430 between receiving an (n−4)^{th} behavior trigger operation and the (n−5)^{th} behavior trigger operation is 1.6, and the time window requirement is not met, the operation counter 1440 stops the accumulative count and clears the accumulated sum.

The operation counter 1440 restarts the accumulative count from the (n−4)^{th} time that the behavior trigger operation is received. There are only 4 countdown intervals 1430 meeting the time window requirement, corresponding behavior trigger operations are: the (n−4)^{th} behavior trigger operation to the n^{th} behavior trigger operation, and the accumulated sum of the operation counter 1440 is 5.

That is, one is added to a count of the behavior trigger operation through the operation counter, so that accuracy of counting can be improved.

According to the method provided in this disclosure, the accumulative count is performed on behavior trigger operations meeting a time window requirement in received behavior trigger operations. When a behavior trigger operation on a first attribute-affecting behavior is received at the n^{th} time, according to an accumulated sum result and sequence numbers of all first segmented sub-behaviors in the first attribute-affecting behavior, the animation in which the master virtual object performs an i^{th} first segmented sub-behavior in the first attribute-affecting behavior is displayed, which can improve diversity of operation manners, control the master virtual object to perform more behaviors, improve efficiency of human-computer interaction, and enrich a content in a displayed picture.

According to the method provided in this embodiment, by starting a countdown timer while the behavior trigger operation is received, when a next behavior trigger operation is received before the countdown timer ends, it is determined that the time window requirement is met between the two behavior trigger operations, thereby improving the efficiency of human-computer interaction.

According to the method provided in this embodiment, through the operation counter, one is added to a count of the received behavior trigger operations meeting the time window requirement, and the accumulative count is performed on all behavior trigger operations meeting the time window requirement, to obtain an accumulated sum. When the behavior trigger operation on the first attribute-affecting behavior is received next time, a sequence number of the first segmented sub-behavior performed by the master virtual object may be determined according to the accumulated sum, thereby improving the diversity of the operation manners, quickly switching to display the master virtual object to perform the corresponding attribute-affecting behavior, and improving the efficiency of human-computer interaction.

In this embodiment, different i^{th} first segmented sub-behaviors are determined according to the attribute-affecting behavior corresponding to the behavior trigger operation, so that diversity of determining manners for determining the i^{th} first segmented sub-behavior can be expanded.

In some embodiments, the plurality of attribute-affecting behaviors equipped by the master virtual object in the virtual scene include, in addition to the first attribute-affecting behavior and the other attribute-affecting behaviors, the second attribute-affecting behavior. The second attribute-affecting behavior also includes a plurality of second segmented sub-behaviors. As shown in FIG. 15, FIG. 15 is a flowchart of a method for displaying a scene in which a virtual object performs an m^{th} second segmented sub-behavior according to an example of this disclosure. The method includes the following operations.

Operation 1510: Display a master virtual object in a virtual scene.

Operation 1510 is the same as operation 710.

Operation 1520: Display, in response to receiving n behavior trigger operations and an n^{th} behavior trigger operation being a trigger operation for a first attribute-affecting behavior, an animation in which the master virtual object performs an i^{th} first segmented sub-behavior in the first attribute-affecting behavior.

Operation 1520 is the same as operation 720.

Operation 1530: Display, in response to receiving an (n+1)^{th} behavior trigger operation that is for a second attribute-affecting behavior and that follows the n^{th} behavior trigger operation and based on an arrangement sequence of a plurality of second segmented sub-behaviors, an animation in which the master virtual object performs an m^{th} second segmented sub-behavior following the i^{th} first segmented sub-behavior.

The m^{th} second segmented sub-behavior is related to a quantity of times n+1 that the behavior trigger operation is received, and the time window requirement is met between operation moments of the n^{th} behavior trigger operation and the (n+1)^{th} behavior trigger operation.

After the master virtual object is controlled to perform the attribute-affecting behaviors corresponding to the foregoing n behavior trigger operations, the behavior trigger operation is received again, that is, the behavior trigger operation on the second attribute-affecting behavior, and the master virtual object is controlled to perform and display the second segmented sub-behavior in the second attribute-affecting behavior.

The first attribute-affecting behavior includes a first segmented sub-behaviors, and the second attribute-affecting behavior includes b second segmented sub-behaviors.

In some embodiments, the determining a sequence number m of the second segmented sub-behavior performed by the master virtual object includes, but is not limited to, the following manners.

(1) Through the operation counter, cumulative count is performed on all received behavior trigger operations meeting the time window requirement, to obtain an operation count sum, and the sequence number m is determined based on the operation count sum; and
when the (n+1)^{th} behavior trigger operation is currently received, the time window requirement is met between operation moments corresponding to first n operations, the time window requirement is also met between operation moments of the n^{th} behavior trigger operation and the (n+1)^{th} behavior trigger operation, the operation count sum is n+1, a ratio takeover operation is performed based on the operation count sum n+1 and the segment quantity b of the second attribute-affecting behavior, and an obtained remainder is a value of the sequence number m.

When the remainder is 0, an animation in which the master virtual object performs a last second segmented sub-behavior in the second attribute-affecting behavior is displayed.

(2) Through the received n^{th} behavior trigger operation on the first attribute-affecting behavior, it is determined that the master virtual object performs the i^{th} first segmented sub-behavior, and the sequence number m is determined based on the sequence number i.

After the value corresponding to the sequence number i is added by one, the ratio takeover operation is performed on the segment quantity b, and an obtained remainder is also the value of the sequence number m.

When the remainder is 0, an animation in which the master virtual object performs a last second segmented sub-behavior in the second attribute-affecting behavior is displayed.

In some embodiments, if the time window requirement is not met between the (n+1)^{th} received behavior trigger operation on the second attribute-affecting behavior and the n^{th} received behavior trigger operation, an animation in which the master virtual object performs a first second segmented sub-behavior in the second attribute-affecting behavior is displayed.

A manner of determining the sequence number m at which the master virtual object performs the second segmented sub-behavior includes, but is not limited to, the foregoing several manners. Alternatively, the sequence number m may be randomly determined, through presetting a specified sequence relationship table, through determining a correspondence between the operation count n+1 and the sequence number m, or in other manners. This is not limited in this embodiment.

In the method provided in this disclosure, the animations in which the master virtual object performs the other attribute-affecting behaviors are displayed by receiving the n−1 behavior trigger operations for the other attribute-affecting behaviors. When the n^{th} behavior trigger operation for the first attribute-affecting behavior is received, the animation in which the master virtual object performs the i^{th} first segmented sub-behavior in the first attribute-affecting behavior is displayed according to the quantity of times n−1 of the behavior trigger operations for the other attribute-affecting behaviors and the sequence number i of all the first segmented sub-behaviors in the first attribute-affecting behavior, so that diversity of operation manners can be improved, the master virtual object is controlled to perform more behaviors, human-computer interaction efficiency is improved, and content in a displayed picture is enriched

According to the method provided in this embodiment, the second attribute-affecting behavior in the plurality of attribute-affecting behaviors is analyzed, and after the master virtual object receives the behavior trigger operations on the other attribute-affecting behaviors and the first attribute-affecting behavior, when the behavior trigger operation on the second attribute-affecting behavior is received again in a case that the time window requirement is met, the animation in which the master virtual object performs the m^{th} second segmented sub-behavior in the second attribute-affecting behavior is displayed, thereby improving the diversity of operation manners, increasing types of behaviors that the master virtual object can perform, enriching the content in the displayed picture, and improving the efficiency of human-computer interaction.

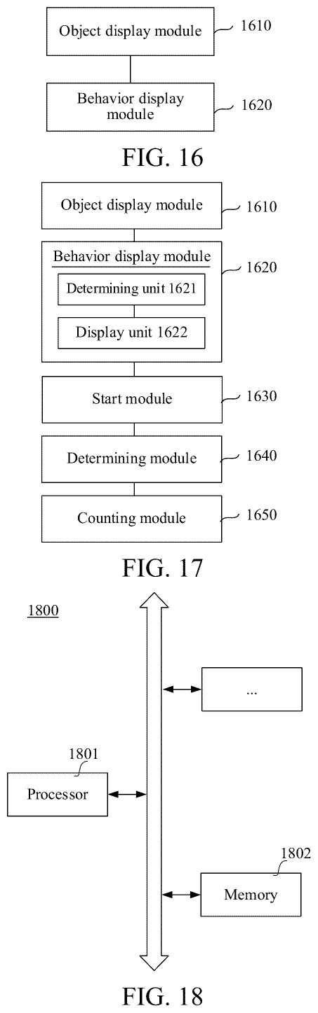

FIG. 16 is a structural block diagram of a virtual object display apparatus according to an example of this disclosure. As shown in FIG. 16, the apparatus includes:
an object display module 1610, configured to display a master virtual object in a virtual scene, the master virtual object being equipped with a plurality of attribute-affecting behaviors in the virtual scene, the plurality of attribute-affecting behaviors including a first attribute-affecting behavior, the first attribute-affecting behavior including a plurality of first segmented sub-behaviors arranged in sequence;
a behavior display module 1620, configured to display, in response to receiving n behavior trigger operations and an n^{th} behavior trigger operation being a trigger operation for the first attribute-affecting behavior and based on the n^{th} behavior trigger operation, an animation in which the master virtual object performs an i^{th} first segmented sub-behavior in the first attribute-affecting behavior, the i^{th} first segmented sub-behavior being related to the quantity of times n of receiving the behavior trigger operations, n and i being positive integers, a time window requirement being met between operation moments of the n behavior trigger operations;
the behavior display module 1620 being further configured to display, based on an arrangement sequence of the plurality of first segmented sub-behaviors in response to receiving a subsequent behavior trigger operation that is for the first attribute-affecting behavior and that follows the n^{th} behavior trigger operation, animations in which the master virtual object performs the plurality of first segmented sub-behaviors in sequence following the i^{th} first segmented sub-behavior, the time window requirement being met between operation moments of the subsequent behavior trigger operation and the n^{th} behavior trigger operation, the time window requirement being that a time interval between two adjacent behavior trigger operations is less than a preset time threshold.

In some embodiments, as shown in FIG. 17, the behavior display module 1620 further includes:
a determining unit 1621, configured to determine, based on a trigger cycle of the plurality of first segmented sub-behaviors in the first attribute-affecting behavior, the i^{th} first segmented sub-behavior corresponding to the quantity of times n from the plurality of first segmented sub-behaviors in response to receiving the n behavior trigger operations are received and the n^{th} behavior trigger operation being the trigger operation for the first attribute-affecting behavior; and
a display unit 1622, configured to display the animation in which the master virtual object performs the i^{th} first segmented sub-behavior in the first attribute-affecting behavior.

In an example, the determining unit 1621 is further configured to obtain, based on a segment quantity of first segmented sub-behaviors in the first attribute-affecting behavior, a remainder of a ratio of the quantity of times n to the segment quantity, to obtain a value of i of the first segmented sub-behavior corresponding to the quantity of times n.

In an example, the determining unit 1621 is further configured to determine a 1^{st} first segmented sub-behavior corresponding to the quantity of times n from the plurality of first segmented sub-behaviors in response to a value of the quantity of times n of the behavior trigger operations being 1; and randomly determine the i^{th} first segmented sub-behavior from the plurality of first segmented sub-behaviors in response to the value of the quantity of times n of the behavior trigger operations being greater than 1; or determine a preset i^{th} first segmented sub-behavior from the plurality of first segmented sub-behaviors in response to the value of the quantity of times n of the behavior trigger operations being greater than 1.

In an example, the determining unit 1621 is further configured to obtain an odd or even number result corresponding to the quantity of times n; and determine, based on a segment quantity of first segmented sub-behaviors in the first attribute-affecting behavior, the i^{th} first segmented sub-behavior corresponding to the odd or even number result from the plurality of first segmented sub-behaviors.

In an example, the determining unit 1621 is further configured to determine, in response to the quantity of times n being an even number, a first segmented sub-behavior corresponding to the even number of times from the plurality of first segmented sub-behaviors as the i^{th} first segmented sub-behavior; or determine, in response to the quantity of times n being an odd number, a first segmented sub-behavior corresponding to the odd number of times from the plurality of first segmented sub-behaviors as the i^{th} first segmented sub-behavior.

In an example, the apparatus further includes:
a start module 1630, configured to start a countdown timer in response to receiving a k^{th} behavior trigger operation, where the countdown timer is a timer using the time window requirement as a timing length, and k is a positive integer less than n; and
a determining module 1640, configured to determine, in response to receiving a (k+1)^{th} behavior trigger operation before the countdown timer ends, that the time window requirement is met between the k^{th} behavior trigger operation and the (k+1)^{th} behavior trigger operation in response to receiving the (k+1)^{th} behavior trigger operation before the countdown timer ends.

In an example, the apparatus further includes:
a counting module 1650, configured to add 1 to a count of a received behavior trigger operation through an operation counter, where the operation counter is configured to perform an accumulative count on behavior trigger operations meeting the time window requirement.

In an example, the behavior display module 1620 is further configured to display, in response to receiving a single trigger operation for the first attribute-affecting behavior, an animation in which the master virtual object performs a 1^{st} first segmented sub-behavior in the first attribute-affecting behavior; or display, in response to receiving n−1 behavior trigger operations for other attribute-affecting behaviors and based on the n−1 behavior trigger operations, animations in which the master virtual object performs the other attribute-affecting behaviors; and display, in response to receiving the n^{th} behavior trigger operation for the first attribute-affecting behavior, the animation in which the master virtual object performs the i^{th} first segmented sub-behavior in the first attribute-affecting behavior, n being an integer greater than 1.

In an example, the plurality of attribute-affecting behaviors further include a second attribute-affecting behavior, and the second attribute-affecting behavior includes a plurality of second segmented sub-behaviors arranged in sequence; and
the behavior display module 1620 is further configured to display, in response to receiving an (n+1)^{th} behavior trigger operation that is for the second attribute-affecting behavior and that follows the nth behavior trigger operation and based on an arrangement sequence of the plurality of second segmented sub-behaviors, an animation in which the master virtual object performs an m^{th} second segmented sub-behavior following the i^{th} first segmented sub-behavior, where the m^{th} second segmented sub-behavior is related to a quantity of times n+1 of receiving behavior trigger operations, and the time window requirement is met between operation moments of the n^{th} behavior trigger operation and the (n+1)^{th} behavior trigger operation.

In conclusion, in the apparatus provided in the embodiments of this disclosure, an attribute-affecting behavior executable by a master virtual object is decomposed into a plurality of segmented sub-behaviors. In this way, the same target control corresponds to a plurality of behaviors. In a case that a quantity of controls is limited, types of the behaviors executable by the master virtual object are increased. In addition, a behavior trigger operation meeting a time window requirement is performed on different controls, sequence numbers of the plurality of segmented sub-behaviors in the target control are switched, and segmented sub-behaviors obtained after a virtual object switches the sequence numbers are displayed, so that efficiency of human-computer interaction is improved and a content in a displayed picture is richer. A plurality of controls are triggered, the master virtual object performs the same attribute-affecting behavior, so that a many-to-one operation manner is implemented and diversity of user operation manners is improved.

The virtual object display apparatus provided in the foregoing embodiments is illustrated with an example of division of the foregoing functional modules. In an example, the functions may be allocated to and completed by different functional modules according to requirements, that is, the internal structure of the device is divided into different functional modules, to implement all or some of the functions described above. In addition, the virtual object display apparatus and the virtual object display method provided in the foregoing embodiments belong to the same concept. For a specific implementation process, refer to the method embodiment, and details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

FIG. 18 is a structural block diagram of a computer device 1800 according to an example of this disclosure. The computer device 1800 may be: a smartphone, a tablet computer, a moving picture experts group audio layer III (MP3) player, a moving picture experts group audio layer IV (MP4) player, a notebook computer, or a desktop computer. The computer device 1800 may be further referred to as another name such as user equipment, a portable terminal, a laptop terminal, or a desktop terminal.

Usually, the computer device 1800 includes: a processor 1801 and a memory 1802.

Processing circuitry, such as the processor 1801 may include one or more processing cores, such as a 4-core processor or an 8-core processor. The processor 1801 may be implemented by using at least one hardware form of a digital signal processing (DSP), a field-programmable gate array (FPGA), and a programmable logic array (PLA). The processor 1801 includes a main processor and a coprocessor. The main processor is configured to process data in an active state, also referred to as a central processing unit (CPU). The coprocessor is a low-power consumption processor configured to process data in a standby state. In some embodiments, the processor 1801 may be integrated with a graphics processing unit (GPU). The GPU is configured to be responsible for rendering and drawing content that needs to be displayed in a display. In some embodiments, the processor 1801 may further include an AI processor. The AI processor is configured to process a computing operation related to machine learning.

The memory 1802, such as a non-transitory computer-readable storage medium, may include one or more computer-readable storage media. The computer-readable storage media may be non-transitory. The memory 1802 may further include a high-speed random access memory and a non-volatile memory, such as one or more disk storage devices and flash storage devices. In some embodiments, the non-transient computer-readable storage medium in the memory 1802 is configured to store at least one instruction. The at least one instruction is executed by the processor 1801 to perform the virtual object display method provided in the method embodiments of this disclosure.

In some embodiments, the computer device 1800 further include another component. A person skilled in the art may understand that the structure shown in FIG. 18 does not constitute a limitation to the terminal 1800, and the computer device 1800 may include more or fewer components than those shown in the figure, or some components may be combined, or a different component deployment may be used. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

the computer-readable storage medium may include: a read only memory (ROM), a random access memory (RAM), a solid state drive (SSD), an optical disc, and the like. The RAM may include a resistance random access memory and a dynamic random access memory. The sequence numbers of the foregoing embodiments of this disclosure are merely for description purpose, and do not indicate the preference among the embodiments.

An embodiment of this disclosure further provides a computer device, including a processor and a memory, the memory having at least one instruction, at least one program, a code set or an instruction set stored therein, and the at least one instruction, the at least one program, the code set or the instruction set being loaded and executed by the processor to implement the virtual object display method according to any one of the foregoing embodiments of this disclosure.

An embodiment of this disclosure further provides a computer-readable storage medium, having at least one instruction, at least one program, a code set or an instruction set stored therein, the at least one instruction, the at least one program, the code set or the instruction set being loaded and executed by a processor to implement the virtual object display method according to any one of the foregoing embodiments of this disclosure.

An embodiment of this disclosure further provides a computer program product or a computer program, the computer program product or the computer program includes computer instructions, and the computer instructions are stored in a computer-readable storage medium. A processor of a computer device reads the computer instructions from the computer-readable storage medium and executes the computer instructions to cause the computer device to perform the virtual object display method according to any one of the foregoing embodiments.

What is claimed is:

1. A virtual object display method, the method comprising:
displaying, by processing circuitry, a virtual object in a virtual scene, the virtual object being configured to perform a plurality of attribute-affecting actions in the virtual scene, each of the plurality of attribute-affecting actions including a plurality of sub-actions;
receiving a first action trigger operation from a user, the first action trigger operation being associated with a first attribute-affecting action of the plurality of first attribute-affecting actions; and
displaying one or more animations of the virtual object performing at least one first sub-action based on an attribute of the first action trigger operation.

2. The method according to claim 1, the method further comprising:
receiving a second action trigger operation from the user, the second action trigger operation being associated with a second attribute-affecting action of the plurality of attribute-affecting actions, and
wherein the displaying the one or more animations of the virtual object further comprises:
determining the at least one first sub-action of the plurality of first sub-actions corresponding to the first attribute-affecting action of the action trigger operation based on a number of action triggers included in the first action trigger operation;
determining at least one second sub-action of the plurality of second sub-actions corresponding to the second attribute-affecting action of the second action trigger operation based on a number of action triggers included in the second action trigger operation; and
displaying the one or more animations of the virtual object based on the determined at least one first sub-action and the at least one second sub-action.

3. The method according to claim 1, the method further comprising:
obtaining, based on a segment quantity of the plurality of first sub-actions in the first attribute-affecting action, a remainder of a ratio of the attribute indicating a number of action triggers included in the first action trigger operation to the segment quantity;
obtaining, based on the remainder, a value of one of the plurality of first sub-actions corresponding to the attribute of the first action trigger operation being received.

4. The method according to claim 1, wherein the displaying the one or more animations further comprises:
determining an initial sub-action of the at least one first sub-action corresponding to the first action trigger operation when the attribute indicates a number of action triggers included in the first action trigger operation is equal to 1; and
determining which sub-action of the at least one first sub-action corresponds to the first action trigger operation when the attribute indicates the number of action triggers included in the first action trigger operation is greater than 1.

5. The method according to claim 1, wherein the displaying the one or more animations further comprises:
obtaining an odd or an even number result corresponding to the attribute; and
determining, based on a segment quantity of the at least one first sub-action corresponding to the plurality of attribute-affecting first actions, the at least one first sub-action corresponding to the odd or the even number result corresponding to the attribute.

6. The method according to claim 5, wherein the determining the at least one first sub-action corresponding to the odd or the even number result corresponding to the attribute further comprises:
determining, when the attribute indicates a number of action triggers included in the first action trigger operation is one of an even number and an odd number, one of the plurality of first sub-actions corresponding to the one of the even number and the odd number indicated by the attribute as the at least one first sub-action.

7. The method according to claim 1, the method further comprising:
starting a countdown timer when the attribute of the first action trigger operation indicates a number of action triggers included in the first action trigger operation is equal to k, wherein the countdown timer is based on a time window requirement, and k is a positive integer; and
determining, when a (k+1)^{th} action trigger operation is received before the countdown timer ends, whether the time window requirement between a k^{th} action trigger operation and the (k+1)^{th} action trigger operation is met.

8. The method according to claim 7, wherein when the time window requirement is met the method further comprises:
adding 1 to a count of the attribute of the first action trigger operation through an operation counter, wherein the operation counter is configured to perform an cumulative count on action triggers meeting the time window requirement.

9. The method according to claim 1, wherein the displaying the one or more animations further comprises:
displaying, when a single action trigger is included in the first action trigger operation, the one or more animations in which the virtual object performs an initial sub-action in an initial attribute-affecting action of the plurality of attribute-affecting actions;
displaying, when more than one action trigger is included in the first action trigger operation, the one or more animations in which the virtual object performs one of the plurality attribute-affecting actions; or
displaying, when more than one action trigger is included in the first action trigger operation, the one or more animations in which the virtual object performs two or more of the plurality attribute-affecting actions.

10. The method according to claim 1, wherein the plurality of attribute-affecting actions includes a first attribute-affecting action and a second attribute-affecting action, and the second attribute-affecting action comprises a plurality of second sub-actions arranged in sequence; and
the method further comprising:
displaying, when an (n+1)^{th} action triggers are received in a second action trigger operation for the second attribute-affecting action, the one or more animations in which the virtual object performs an (m+1)^{th} second sub-action, wherein the (m+1) second sub-action is related to the n+1 action triggers that is received, and a time window requirement is met between a n^{th} action trigger and the (n+1)^{th} action trigger.

11. A display apparatus, comprising:
processing circuitry configured to:
display a virtual object in a virtual scene, the virtual object being configured to perform a plurality of attribute-affecting actions in the virtual scene, each of the plurality of attribute-affecting actions including a plurality of sub-actions;
receive a first action trigger operation from a user, the first action trigger operation being associated with a first attribute-affecting action of the plurality of first attribute-affecting actions; and
display one or more animations of the virtual object performing at least one first sub-action based on an attribute of the first action trigger operation.

12. The apparatus according to claim 11, wherein the processing circuitry is configured to:
receive a second action trigger operation from the user, the second action trigger operation being associated with a second attribute-affecting action of the plurality of attribute-affecting actions, and
determine the at least one first sub-action of the plurality of first sub-actions corresponding to the first attribute-affecting action of the action trigger operation based on a number of action triggers included in the first action trigger operation;
determine at least one second sub-action of the plurality of second sub-actions corresponding to the second attribute-affecting action of the second action trigger operation based on a number of action triggers included in the second action trigger operation; and
display the one or more animations of the virtual object based on the determined at least one first sub-action and the at least one second sub-action.

13. The apparatus according to claim 11, wherein the processing circuitry is configured to:
determine an initial sub-action of the at least one first sub-action corresponding to the first action trigger operation when the attribute indicates a number of action triggers included in the first action trigger operation is equal to 1; and
determine which sub-action of the at least one first sub-action corresponds to the first action trigger operation when the attribute indicates the number of action triggers included in the first action trigger operation is greater than 1.

14. The apparatus according to claim 11, wherein the processing circuitry is configured to:
obtain an odd or an even number result corresponding to the attribute; and
determine, based on a segment quantity of the at least one first sub-action corresponding to the plurality of attribute-affecting first actions, the at least one first sub-action corresponding to the odd or the even number result corresponding to the attribute.

15. The apparatus according to claim 14, wherein the processing circuitry is configured to:
determine, when the attribute indicates a number of action triggers included in the first action trigger operation is one of an even number and an odd number, one of the plurality of first sub-actions corresponding to the one of the even number and the odd number indicated by the attribute as the at least one first sub-action.

16. A non-transitory computer-readable storage medium, storing instructions which when executed by a processor cause the processor to perform:
displaying a virtual object in a virtual scene, the virtual object being configured to perform a plurality of attribute-affecting actions in the virtual scene, each of the plurality of attribute-affecting actions including a plurality of sub-actions;
receiving a first action trigger operation from a user, the first action trigger operation being associated with a first attribute-affecting action of the plurality of first attribute-affecting actions; and
displaying one or more animations of the virtual object performing at least one first sub-action based on an attribute of the first action trigger operation.

17. The non-transitory computer-readable storage medium according to claim 16, wherein the instructions when executed by the processor further cause the processor to perform:
receiving a second action trigger operation from the user, the second action trigger operation being associated with a second attribute-affecting action of the plurality of attribute-affecting actions, and
wherein the displaying the one or more animations of the virtual object further comprises:
determining the at least one first sub-action of the plurality of first sub-actions corresponding to the first attribute-affecting action of the action trigger operation based on a number of action triggers included in the first action trigger operation;
determining at least one second sub-action of the plurality of second sub-actions corresponding to the second attribute-affecting action of the second action trigger operation based on a number of action triggers included in the second action trigger operation; and
displaying the one or more animations of the virtual object based on the determined at least one first sub-action and the at least one second sub-action.

18. The non-transitory computer-readable storage medium according to claim 16, wherein the instructions when executed by the processor further cause the processor to perform:
determining an initial sub-action of the at least one first sub-action corresponding to the first action trigger operation when the attribute indicates a number of action triggers included in the first action trigger operation is equal to 1; and
determining which sub-action of the at least one first sub-action corresponds to the first action trigger operation when the attribute indicates the number of action triggers included in the first action trigger operation is greater than 1.

19. The non-transitory computer-readable storage medium according to claim 16, wherein the instructions when executed by the processor further cause the processor to perform:
obtaining an odd or an even number result corresponding to the attribute; and
determining, based on a segment quantity of the at least one first sub-action corresponding to the plurality of attribute-affecting first actions, the at least one first sub-action corresponding to the odd or the even number result corresponding to the attribute.

20. The non-transitory computer-readable storage medium according to claim 19, wherein the instructions when executed by the processor further cause the processor to perform:
determining, when the attribute indicates a number of action triggers included in the first action trigger operation is one of an even number and an odd number, one of the plurality of first sub-actions corresponding to the one of the even number and the odd number indicated by the attribute as the at least one first sub-action.
